(19) United States
(12) Patent Application Publication
(10) Pub. No.: US 2026/0091429 A1
(43) Pub. Date: Apr. 2, 2026

(54) ROBOTIC HEATING COIL FOR CONTROLLED HEAT DISTRIBUTION

(71) Applicant: INTERNATIONAL BUSINESS MACHINES CORPORATION, Armonk, NY (US)

(72) Inventors: Sarbajit Kumar Rakshit, Kolkata (IN); Zachary Augustus Silverstein, Georgetown, TX (US); Jeremy R. Fox, Georgetown, TX (US); Logan Bailey, Atlanta, GA (US)

(21) Appl. No.: 18/903,705

(22) Filed: Oct. 1, 2024

(51) Int. Cl. B22F 10/64; B29C 71/02; B33Y 40/20; H05B 1/02

(52) U.S. Cl. CPC B22F 10/64; B29C 71/02; B33Y 40/20; H05B 1/023

(57) ABSTRACT

Methods and systems for heat treatment include determining heat treatment needs for a three-dimensional (3D) object. A heating structure is designed to supply the heat treatment needs of the 3D object. The heating structure is assembled from modular heating structures that include heating elements. Heat treatment is performed on the 3D object using the heating structure.

### BACKGROUND

The present invention generally relates to heat treatment and, more particularly, to robotic heating coils.

Heat treatment is a process that modifies the physical and chemical properties of a material, such as in metallurgical applications and plastics. Heat treatment is used to heat or chill the material to a target temperature to change its properties, such as hardening or softening the material. Exemplary heat treatment techniques include annealing, case hardening, precipitation strengthening, tempering, carburizing, normalizing, and quenching. Exemplary properties that can be changed by heat treatment include strength, hardness, ductility, toughness, wear resistance, elasticity, and magnetic properties. Heat treatment can also reduce internal stresses of a material.

While heat treatment refers specifically to intentional temperature changes, incidental heating and cooling can occur during other manufacturing processes, such as in hot forming and welding.

### SUMMARY

A method for heat treatment includes determining heat treatment needs for a three-dimensional (3D) object. A heating structure is designed to supply the heat treatment needs of the 3D object. The heating structure is assembled from modular heating structures that include heating elements. Heat treatment is performed on the 3D object using the heating structure.

A computer system for heat treatment includes a processor set, one or more computer readable storage media, and program instructions stored on the one or more storage media. The program instructions cause the processor set to perform operations comprising determining heat treatment needs for a 3D object, designing a heating structure to supply the heat treatment needs of the 3D object, triggering assembly of the heating structure from modular heating structures that include heating elements, and triggering heat treatment on the 3D object using the heating structure.

A modular heating structure includes a body having a first surface and a joining surface, a heating element on the first surface, and an attachment structure on the joining surface that is configured to join with a corresponding attachment structure on another heating structure.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a diagram of a heating structure made up of modular heating components, assembled to form a shell around an object that is to be subjected to a heat treatment process, in accordance with an embodiment of the present invention;

FIG. 2 is a block/flow diagram of a method for applying heat treatment to an object using modular heating components to form a heating structure, in accordance with an embodiment of the present invention;

FIG. 3 is an isometric view of a modular heating component, which can be assembled with other such components to form a heating structure, in accordance with an embodiment of the present invention;

FIG. 4 is a block/flow diagram of a method for designing a heating structure, in accordance with an embodiment of the present invention; and

FIG. 5 is a block diagram of a computing environment that can be used to perform automated heat treatment, in accordance with an embodiment of the present invention.

### DETAILED DESCRIPTION

Heat treatment can be applied to objects of varying shapes and sizes, such as three-dimensional (3D) printed objects, using a modular heating system that can be configured to apply heat exactly as needed for a given target. In contrast to heat treatment in a furnace or other fixed structure, robotic heating coils can be used to conform to the particular dimensions of the target to minimize wasted heat and to accommodate objects of arbitrary size. The robotic heating coil can furthermore provide a tailored heat profile that can accommodate the different thermal needs of different materials and different structural thicknesses.

In some cases, the robotic heating coils may be self-assembling, or may be assembled by a robotic system that automatically configures them to accommodate a given 3D object. In some cases the heating coils may be modular and may have one or more embedded heating elements that can be selectively enabled to provide the tailored heat profile. For large objects, the heating coils may be assembled around the object so that heat is not lost through an access door.

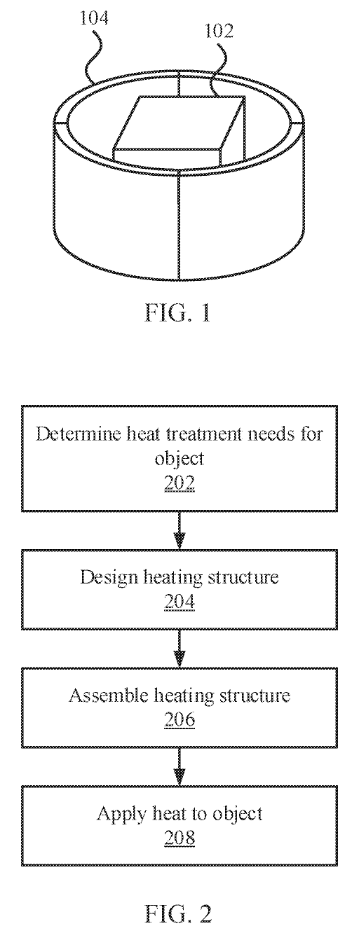

Referring now to FIG. 1, an exemplary heat treatment is shown. A 3D object 102 is shown within a heat treatment chamber established by a set of modular heating structures 104. In this example, the modular heating structures 104 join together to form a circle around the 3D object 102. The modular heating structures 104 may include heating coils or any other appropriate heat source that can be selectively engaged to produce heat. The heat emanates from the inner surfaces of the modular heating structures 104 to increase the temperature of the 3D object 102.

Although the modular heating structures 104 are shown in the shape of quarter-cylinder shells for simplicity, it should be understood that any appropriate shape may be used instead. For example, the shape of the modular heating structures 104 may be selected to match and conform to an outer shape of the 3D object 102. For the cubic 3D object 102 shown herein, that could mean rectangular modular heating structures.

Although the modular heating structures 104 are shown without a cover to show the 3D object 102 within, it should be understood that the modular heating structures 104 may include a heated cover as well as a heated base. The 3D object 102 may thus be entirely contained within a chamber formed by assembling the modular heating structures 104.

The modular heating structures 104 may be powered by any appropriate mechanism. In the case that heating coils are used, an appropriate electrical power supply may be used to supply a current to the heating coils. The magnitude of the current may be selected to generate a corresponding amount of heat, in accordance with a target temperature or temperatures of the 3D object 102. Actuators may be used to control the relative positions of the heating coils so that they can be placed at locations where heat treatment is needed. The modular heating structures 104 may further include embedded computer systems to precisely control heat distribution, for example including microcontrollers and sensors that monitor temperature and adjust heating elements in real-time, ensuring optimal thermal profiles.

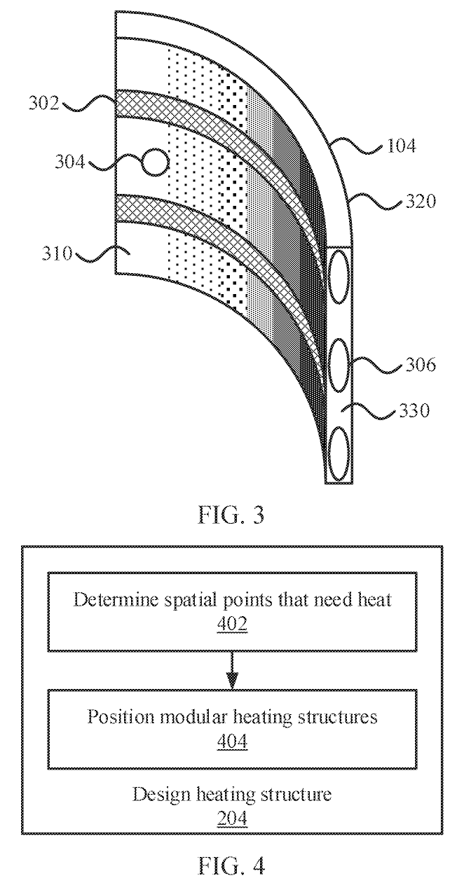

Referring now to FIG. 2, a heat treatment method is shown. Block 202 determines the heat treatment needs of a 3D object. This determination may be based on the material or materials that make up the 3D object as well as historical data of similar shapes. For example, thicker portions of the 3D object may need to have more heat locally applied, or may need to have heat applied for a longer period of time. In contrast, thinner structures may need to have less heat applied locally to prevent thermal damage. Certain materials may need more heat for treatment, whereas other materials in the same 3D object may need lower temperatures for treatment, or may need to remain below a given temperature to prevent damage (e.g., melting or deformation).

Block 204 then designs a heating structure that can meet the heat treatment needs of the 3D object. This design may include multiple modular heating structures of any appropriate size and shape. In some cases the modular heating structures may have a predetermined shape or set of shapes. In some cases, the modular heating structures may include custom shapes that are fabricated (e.g., by 3D printing) for the purpose of conforming to a specific 3D object. The design for the heating structure may therefore specify a number and type of modular heating structures and may furthermore include an arrangement of the modular heating structures to assemble the heating structure. The design optimizes power usage by applying heat in accordance with the properties of the 3D object, its shape and dimensions, and the time needed for heat treatment.

Block 206 then assembles the heating structure. In some cases, the heating structure may be assembled manually. In some cases, some or all of the heating structure may be assembled automatically by robotic tools. The heating structure may be assembled around the 3D object, or may be assembled with an opening into which the 3D object may be inserted. In some cases multiple such heating structures may be assembled, to help parallelize the heat treatment process during manufacturing of many 3D objects.

Block 208 applies heat to the 3D object using the assembled heating structure. The heating process may apply different amounts of heat at different points within the heating structure, for example by applying differing amounts of current to heating coils in the different modular heating structures. In some cases a single modular heating structure may include multiple heating coils, which may be selectively controlled with different amounts of current. The heat may be applied by different amounts of time for different heating coils. The heating process may further be controlled using feedback from sensors that monitor the temperature of particular regions of the 3D object. The sensors may include, e.g., infrared temperature sensors, thermocouples, thermometers, etc. If a region of the 3D object is being heated too much, or not enough, block 208 may adjust the current flow to a corresponding heating coil.

In some cases the heating structure may be assembled to integrate with a workflow process, such as by being formed on or around a conveyor. The 3D object may then pass through the heating structure for heat treatment without manual intervention after it is fabricated.

Determining the heat treatment needs in block 202 may be based on a set of specifications for the 3D object, for example including a shape specified in a 3D computer aided design (CAD) format such as STL. In some cases, where 3D CAD information is not available, a 3D scan of the 3D object may be performed, for example using cameras and/or other sensors to gather visual information about the 3D object. Image processing may be performed, including object detection, object recognition, and semantic segmentation, to identify the shapes and dimensions of the 3D object. This information may further be used to extract information regarding the materials that make up the 3D object. In some cases the 3D scan may be used to determine whether heat treatment is needed.

The design of the heating structure in block 204 may employ a simulation model to determine an optimal arrangement of the modular heating structures. The simulation model identifies an arrangement of modular heating structures that ensures controlled heating around the 3D object. This design takes into account the materials of the 3D object, for example specifying different levels of heat to accommodate different material properties. The simulation may take thermal properties of the materials and set boundary conditions. Computational fluid dynamics may be used to simulate heat transfer dynamics, providing visualization of temperature gradients and heat distribution around the coverage area. The simulation analyzes the resulting data to identify optimal positions for modular heating structures, ensuring efficient heat distribution and minimizing heat loss.

Machine learning may be used to optimize the heat treatment process, for example by analyzing historical data on material properties and heat treatment outcomes. The machine learning model may be trained on various 3D objects’ responses to heat and can be used to predict the idea heating profile needed for different materials and geometries. This provides for dynamic adjustments during treatment, ensuring precise temperature control.

Referring now to FIG. 3, additional detail is shown for a modular heating structure 104. The modular heating structure 104 may include an inner surface 310, an outer surface 320, and one or more joining surfaces 330. The inner surface 310 is arranged to face toward the 3D object and includes one or more heating elements 302, such as heating coils. These heating elements 302 may be controlled by integrated circuitry or may be controlled by an external power supply by, e.g., applying a current. In some cases the heating elements 302 may be integrated into a body of the modular heating structure 104 and in some cases the heating elements 302 may be affixed to the inner surface 310. In some cases there may be heating elements 302 on both the inner surface 310 and the outer surface 320.

The modular heating structure 104 is shown as being a quarter-cylindrical shell, with the inner surface 310 being concave. It should be understood that the modular heating structure 104 may have any appropriate shape, including a rectangular prism or a custom shape that conforms to the shape of the 3D object. While circular sections are specifically described herein, the modular heating structure 104 may also take the form of sections of an oval or any other round or polyhedral shape.

The modular heating structure 104 may be attached to other modular heating structures 104 by attachment structures 306. These attachment structures may be any appropriate mechanism, such as magnetic attachment points, hooks, glue, hinges, or joints. The attachment structure should be selected to be robust against significant changes in temperature. The modular heating structure 104 should be formed from a material that is selected to have a low coefficient of thermal expansion, so that the thermal treatment process does not cause stress at the attachment structures 306 between modular heating structures 104.

The modular heating structure 104 may include one or more sensors 304. These sensors 304 may include, e.g., temperature sensors and optical sensors to monitor the status of the heat treatment process and to monitor the condition of the 3D object. For example, temperature information may be collected from the modular heating structure 104 itself to ensure that the heating elements 302 are operating as intended and further may be collected from the 3D object to ensure that it is being heated as intended.

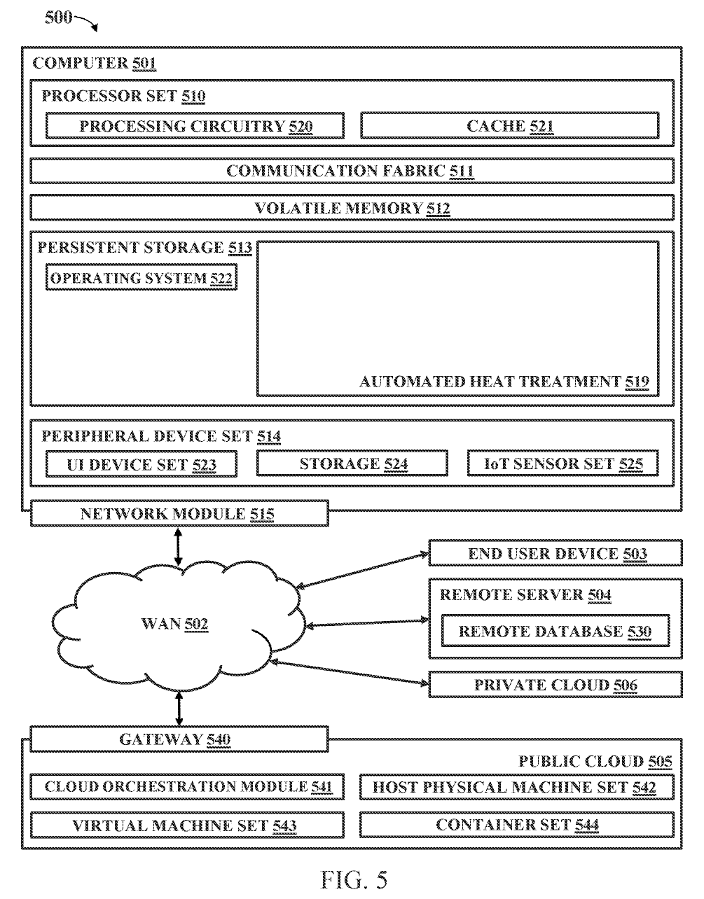

Referring now to FIG. 4, additional detail on designing the heating structure 204 is shown. Block 402 determines points in space that need heat based on the heat treatment needs of the 3D object. Block 404 then positions modular heating structures in accordance with these heat needs.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Referring now to FIG. 5, computing environment 500 is shown as an example of an environment for the execution of at least some of the computer code involved in performing the inventive methods, such as automated heat treatment 519. In addition to block 519, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 519, as identified above), peripheral device set 514 (including user interface (UI) device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in block 519 in persistent storage 513.

COMMUNICATION FABRIC 511 is the signal conduction path that allows the various components of computer 501 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, volatile memory 512 is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface-type operating systems that employ a kernel. The code included in block 519 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515. WAN 502 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of a robotic heating coil for controlled heat distribution (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A method for heat treatment, comprising:
determining heat treatment needs for a three-dimensional (3D) object;
designing a heating structure to supply the heat treatment needs of the 3D object;
assembling the heating structure from modular heating structures that include heating elements; and
performing heat treatment on the 3D object using the heating structure.

2. The method of claim 1, wherein assembling the heating structure is performed automatically using a robotic system.

3. The method of claim 1, wherein performing the heat treatment includes applying differing amounts of heat to different parts of the 3D object.

4. The method of claim 3, wherein the heat treatment needs include multiple temperature limits corresponding to different materials of the 3D object.

5. The method of claim 1, wherein performing the heat treatment includes monitoring a temperature of the 3D object and adjusting the heat treatment responsive to the temperature.

6. The method of claim 5, wherein monitoring the temperature collects temperature information from a temperature sensor integrated with at least one of the modular heating structures.

7. The method of claim 1, wherein performing heat treatment includes applying a current to a heating coil of the heating structure.

8. The method of claim 1, wherein assembling the heating structure includes connecting attachment structures on edges of the modular heating structures to connect them to one another.

9. A computer system for heat treatment, comprising:
a processor set;
one or more computer readable storage media; and
program instructions stored on the one or more storage media to perform operations comprising:
determining heat treatment needs for a three-dimensional (3D) object;
designing a heating structure to supply the heat treatment needs of the 3D object;
triggering assembly of the heating structure from modular heating structures that include heating elements; and
triggering heat treatment on the 3D object using the heating structure.

10. The system of claim 9, wherein assembly of the heating structure is performed automatically using a robotic system.

11. The system of claim 9, wherein the heat treatment includes an application of differing amounts of heat to different parts of the 3D object.

12. The system of claim 11, wherein the heat treatment needs include multiple temperature limits corresponding to different materials of the 3D object.

13. The system of claim 9, wherein the heat treatment includes monitoring a temperature of the 3D object and adjusting the heat treatment responsive to the temperature.

14. The system of claim 13, wherein monitoring the temperature collects temperature information from a temperature sensor integrated with at least one of the modular heating structures.

15. The system of claim 9, wherein triggering the heat treatment includes applying a current to a heating coil of the heating structure.

16. The system of claim 9, wherein triggering assembly of the heating structure includes connecting attachment structures on edges of the modular heating structures to connect them to one another.

17. A modular heating structure, comprising:
a body having a first surface and a joining surface;
a heating element on the first surface; and
an attachment structure on the joining surface that is configured to join with a corresponding attachment structure on another heating structure.

18. The modular heating structure of claim 17, wherein the body is curved and wherein the first surface is a concave surface.

19. The modular heating structure of claim 17, further comprising a temperature sensor on the first surface.

20. The modular heating structure of claim 19, further comprising an embedded computer system configured to control operation of the heating element based on information from the temperature sensor.
